(19) United States
(12) Patent Application Publication
(10) Pub. No.: US 2022/0211042 A1
(43) Pub. Date: Jul. 7, 2022

(54) SURFACE TREATMENT ARTICLES, DEVICES AND METHODS FOR MAKING THE SAME

(71) Applicant: SoClean, Inc., Peterborough, NH (US)

(72) Inventors: Dean MARCARELLI, Peterborough, NH (US); Robert WILKINS, Peterborough, NH (US); Robert A. CHARLES, New Boston, NH (US)

(21) Appl. No.: 17/454,677

(22) Filed: Nov. 12, 2021

Related U.S. Application Data
(60) Provisional application No. 63/133,567, filed on Jan. 4, 2021.
(60) Provisional application No. 63/164,280, filed on Mar. 22, 2021.

(51) Int. Cl. A01N 59/00; C11D 17/04; C11D 11/00; C11D 3/39; C09G 1/04; A01N 25/08; A01P 1/00; B24D 11/00

(52) U.S. Cl. CPC A01N 59/00; C11D 17/049; C11D 11/0023; C11D 3/3942; B24D 11/00; C09G 1/04; A01N 25/08; A01P 1/00; C11D 3/3947

(57) ABSTRACT

Surface treatment articles, systems for making/loading surface treatment articles, and methods of making surface treatment articles are described. In embodiments the surface treatment articles are configured to be impregnated or otherwise loaded with a surface treatment liquid that includes a carrier and an active agent. The carrier may be or include water, and the active agent may be or include dissolved ozone, ozone degradation products, and/or ozone reaction products. The surface treatment liquid may contain a threshold concentration of active agent for a residence time that is sufficient for desired cleaning, disinfecting, and/or polishing applications.

### CROSS REFERENCE TO RELATED APPLICATIONS

This application claims benefit of priority to U.S. Provisional Application No. 63/133,567 (filed Nov. 13, 2020) and U.S. Provisional Application No. 63/164,280 (filed Mar. 22, 2021), the entire content of both of which is incorporated herein by reference.

### FIELD

The present disclosure is generally directed to surface treatment articles and systems for making/loading surface treatment articles. Methods for making/loading surface treatment articles are also described.

### BACKGROUND INFORMATION

The surfaces of various items such as counters (e.g., granite counters, tables (e.g., wooden tables), electronic devices, cutting boards, stainless steel appliances, etc. can become fouled with contaminants such as dirt, debris, dust, fingerprints, smudges, food, grime, bacteria, viruses, and the like. Dirty surfaces can be unsightly and difficult to clean or polish to the satisfaction of a user.

Various products have been developed to treat dirty surfaces with a surface treatment agent such as chlorine bleach, percarbonates (e.g., sodium percarbonate), peroxides (e.g., hydrogen peroxide), alcohols (e.g., ethyl alcohol, isopropyl alcohol, etc.), acids, bases, surface polishing compositions, combinations thereof, and the like. Such agents may be mixed with or dissolved in water or other liquid to form a surface treatment liquid that can be dispersed onto a surface, e.g., via a pre-impregnated wipe or spraying from a bottle. Disinfecting wipes that are impregnated or otherwise loaded with a surface treatment liquid are also available and may be used to apply the liquid to a surface by wiping. Once applied, the surface treatment liquid may be allowed to remain on the surface, e.g., to disinfect, clean or polish the surface. The surface treatment liquid may then be removed from the surface, e.g., by evaporation, wiping with an absorbent article, buffing or the like.

While known surface treatment liquids and agents are effective, they are not without limitations. For example, some surface treatment agents and liquids can irritate the skin and/or mucous membranes, potentially making them undesirable to certain users. Surface treatment agents and liquids can also be a health hazard—particularly to children—and thus special care may be needed to ensure that they are properly and securely stored. Known surface treatment liquids and agents can also generate considerable waste, as users often remove them from surfaces using absorbent articles such as paper towels, which are then discarded. This is particularly true with disinfecting wipes, which are designed to provide a highly convenient means for sanitizing surfaces with one-time use cloths that are quickly discarded. Still further, many known surface treatment liquids and agents are surface specific, requiring users to have several products for cleaning different surfaces. And finally, many known surface treatment liquids and agents can leave an unsightly residue behind, particularly if they are allowed to evaporate from a surface without the surfaced being wiped or buffed.

A need therefore remains for improved surface treatment articles, as well as systems and methods for making/loading surface treatment articles.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 is a block diagram of one example of a system for loading surface treatment articles consistent with the present disclosure.

FIG. 2 is a block diagram of another example of a system for loading surface treatment articles consistent with the present disclosure.

FIGS. 3A-3D illustrate examples of a surface treatment article consistent with the present disclosure.

FIG. 4 illustrates one example of a surface treatment device consistent with the present disclosure.

FIG. 5 is a block diagram of one example of a stand for use in loading a surface treatment article/device consistent with the present disclosure.

FIG. 6 is a flow chart of example operations of one example of a method of loading surface treatment articles/devices consistent with the present disclosure.

### DETAILED DESCRIPTION

The present disclosure is generally directed to surface treatment articles and systems for making/loading the same. Methods for making/loading surface treatment articles and methods of using surface treatment articles are also described. As will be described below, the surface treatment articles may include a substrate that is impregnated or otherwise loaded with a surface treatment liquid. The surface treatment liquid includes a base liquid (also referred to herein as a “carrier” or “carrier liquid”) and one or more surface treatment agents (also referred to herein as “active agent” or “active agents”. In embodiments the carrier is water, and the active agent is or includes ozone, reaction products of ozone (e.g., resulting from a reaction of ozone with the carrier, impurities in the carrier, and/or the substrate), and/or decomposition products of ozone (e.g., resulting from decomposition of ozone when it is dissolved in or contacts the carrier). The surface treatment articles described herein are generally configured to apply the surface treatment liquid to a surface, resulting in one or more of cleaning, polishing, and/or disinfection of the surface. When the surface treatment liquid in a surface treatment article is spent (e.g., the amount of surface treatment liquid impregnated into the surface treatment article falls below a threshold volume and/or the concentration of active agent(s) in the surface treatment liquid falls below a threshold concentration), the surface treatment article may be conveniently re-loaded with surface treatment liquid by a user.

As used herein the term “about,” when used in connection with a value or a range, means plus or minus 5% of the indicated value or the endpoints of the range. Thus, for example, about 5% means 4.75% to 5.25%. Similarly, about 5 to about 10% means 4.75 to 10.5.

From time to time the present application describes features using numerical ranges. Such ranges should be understood to include the recited endpoints, and to encompass any intermediate ranges within the stated range. Thus, for example, the range “1 to 10” should be understood to include the endpoints 1 and 10, as well intermediate ranges therein (e.g., from 1 to 9, 2 to 10, 2 to 9, 3 to 9, 4 to 9, etc.) as if those intermediate ranges were expressly recited.

The term “surface treatment article” is used herein to refer to items that are configured to apply a surface treatment liquid to a surface, e.g., to disinfect, clean, and/or polish the surface. The term “surface treatment liquid” is used herein to refer to a liquid that includes a carrier that is loaded or otherwise impregnated with a one or more active agents. The terms “surface treatment agent” and “active agent” are interchangeably used herein to mean a compound or composition that, when applied to a surface, can clean, disinfect, and/or polish that surface.

In some embodiments the surface treatment articles described herein include a substrate that is configured to be loaded with a carrier in any suitable manner. For example, the substrate may be loaded with the carrier by wetting, impregnating, or any other suitable process. Before or after it is loaded into the substrate, the carrier may be loaded with one or more active agents such as ozone, reaction products of ozone, decomposition products of ozone, and the like. Loading the carrier with the active agent(s) may be performed in any suitable manner. For example, when the active agent is or includes ozone, reaction products of ozone, and/or decomposition products of ozone, the carrier may be loaded with the active agents by exposing the carrier (alone or when it is loaded into a substrate) to ozone gas, e.g., in a compartment. Exposing the carrier to ozone may cause the carrier liquid to become loaded with active agent(s), such as ozone, reaction products of ozone, and/or decomposition products of ozone. The reaction products of ozone may be the product of a chemical reaction between ozone and carrier (e.g., water), a reaction between ozone and solutes in the carrier, and/or a reaction of ozone and the substrate. The decomposition products of ozone may be the result of the decomposition of ozone when it is dissolved in or contacts the carrier (e.g., water). Non-limiting examples of substrates that may be used include sponges, a woven or non-woven article) (e.g., a woven or non-woven cloth such as a microfiber cloth, a cotton cloth, or the like), combinations thereof, and the like.

In embodiments the surface treatment articles described herein include a substrate in the form of a microfiber or cotton cloth. Such cloths can be wetted with water as a carrier to a drip-dry state. The water can then be impregnated or otherwise loaded with one or more active agents as described above to make a surface treatment article. For example, a cloth wetted to a drip dry state with water may be placed into a compartment. Ozone gas may be introduced into the compartment with a cycle time that may range from greater than 0 to about 30 minutes, such as from about 1, 2, 5, 10 or about 20 minutes. As a result, the water within the wetted cloth becomes impregnated or otherwise loaded with one or more active agents, such as ozone, reaction products of ozone (e.g., with water, solutes in the water, and/or the substrate), decomposition products of ozone, combinations thereof, and the like, resulting in the production of a surface treatment article consistent with the present disclosure. Notably and as will be described later, the surface treatment article may have surprising and unexpected cleaning, polishing and/or disinfection performance for a significant amount of time after it is loaded with the active agent(s). For example, the surface treatment article may exhibit strong disinfection properties (alone or in combination with polishing performance and/or cleaning performance) for ≥10, ≥15, ≥20, ≥25, or even ≥30 minutes.

In other embodiments the surface treatment articles described herein include a reservoir and a dispensing head. In such embodiments the reservoir is configured to contain a surface treatment liquid, such as water that has been loaded with one or more active agents as described above. Without limitation, the surface treatment articles described herein may be configured to apply a surface treatment liquid to a surface to be treated, e.g., by wiping, spraying, or the like. Systems for forming surface treatment articles and methods of forming such articles are also described.

More specifically, in embodiments the surface treatment articles include or are in the form of a substrate that is loaded with a surface treatment liquid. Any suitable substrate may be used provided it can be adequately loaded with the surface treatment liquid. For example, the substrate may be in the form of or include a sponge and/or a woven or non-woven cloth that is made of natural or synthetic material, such as but not limited to natural fibers, synthetic fibers, or a combination thereof. In embodiments the substrate is in the form of a microfiber cloth, a cotton cloth, or a combination thereof. The substrate may optionally include one or more layers of absorbent or adsorbent material. Such layer(s) may be configured to be loaded with a carrier, such that the carrier is retained therein by adsorption, absorption, combinations thereof, and the like. In other embodiments the present disclosure is drawn to surface treatment articles that include a body with a reservoir and a head coupled to the body. The reservoir is configured to contain a surface treatment liquid, which can be dispensed onto a surface via the head.

The surface treatment liquids described herein generally include a carrier and one or more active agents, either alone or in combination with other ingredients. The carrier may be any liquid that can form a solution, mixture, dispersion, emulsion, or chemically react etc. with the active agent. Water is one example of a suitable carrier, but other liquids (e.g., organic and/or or inorganic solvents) may also be used. In embodiments, the carrier includes water, either alone or in combination with one or more other liquids. In other embodiments, the carrier consists or consists essentially of water.

The active agents described herein may be any composition that has desired surface disinfection, cleaning, and/or polishing properties. In embodiments the active agent is configured to kill or otherwise neutralize bacteria, viruses, and/or other undesirable biologic agents on a surface. In those or other embodiments the active agent may be configured to clean a surface, i.e., to facilitate removal of debris and other contaminants from a surface. Likewise, the active agent may be configured to polish a surface, i.e., to provide a smooth glossy surface when applied to a surface and rubbed, e.g., by buffing or another similar action. In embodiments, the active agent is a multipurpose agent, meaning that it can perform at least two (and in some cases all) of disinfecting, cleaning, and/or polishing when applied to a surface.

Various types of active agents may be used in the surface treatment articles herein. Non-limiting examples of such active agents include ozone (e.g., dissolved in a carrier), decomposition products of ozone, and reaction products of ozone with a carrier and/or a substrate. In some embodiments the surface treatment agent consists or consists essentially of ozone, reaction products formed by a reaction between ozone and the carrier, solutes in the carrier, or the substrate, and/or decomposition products of ozone, e.g., resulting from the interaction of ozone with the carrier and/or the substrate. Without limitation, the surface treatment liquid preferably consists essentially of or consists of a carrier and an active agent, wherein the carrier consists essentially of water and solutes therein (e.g. as typically contained in undistilled water) and the active agent consists or consists essentially of ozone, reaction products of ozone with the carrier and/or solutes therein, and/or decomposition products of ozone, e.g., resulting from interaction of ozone with the carrier and/or a substrate.

The surface treatment liquid may be produced by loading the carrier with the active agent(s) in any suitable manner. In embodiments, the carrier is loaded with surface treatment agent(s) by performing an agent loading process that includes contacting the carrier with a sanitizing gas such as ozone e.g., before or after the carrier is impregnated or otherwise loaded into a substrate or a reservoir. For example, when the surface treatment article includes a cloth substrate (e.g., a microfiber and/or cotton cloth) and the carrier is water, the cloth may be wetted (e.g., to a drip-dry state) with water before or after it is placed into a chamber. An agent loading process may then be performed to load the carrier with an active agent.

In embodiments the agent loading process includes contacting a sanitizing gas (e.g., ozone gas) with the carrier in a chamber. Contact between the carrier and the sanitizing gas may result in the carrier becoming loaded with one or more surface treatment agents. For example, contact between the sanitizing gas and the carrier may cause the sanitizing gas to dissolve into the carrier, after which the dissolve sanitizing gas (e.g., ozone) can act as an active agent. Alternatively, contact between the sanitizing gas and the carrier may cause the sanitizing gas (e.g., ozone) to react with the carrier and/or a substrate in which the carrier is loaded, forming reaction products that can act as a sanitizing agent. Still further, contact between the carrier and the sanitizing gas may cause the sanitizing gas to decompose into decomposition products that can act as an active agent. For example, when water is the carrier and ozone is the sanitizing gas, exposure of the water to ozone can cause ozone to dissolve into the sanitizing gas, whereupon it can act as an active agent. The ozone can also react with water and solutes therein to form radicals and ionized species which can also act as an active agent. Moreover, contact between water and ozone may cause the ozone to decompose into decomposition products such as hydroxyl (OH) ions and other species, which can also act as an active agent. into one or more decomposition products, resulting in the formation of a surface treatment agent.

In embodiments, the agent loading process is performed by contacting the carrier with the sanitizing gas before the carrier is loaded into a substrate. In other embodiments, the agent loading process is performed after the carrier is loaded into a substrate as described above. Without limitation, the agent loading process is preferably performed after the substrate is loaded with a carrier.

The concentration of surface treatment agent(s) in the surface treatment liquid may depend on various factors, such as the length of the agent loading process, the concentration of sanitizing gas within the chamber during the agent loading process, the surface area of the substrate, the surface area of the carrier exposed to the sanitizing gas, the amount of carrier within the substrate, the solubility of the sanitizing gas within the carrier, the concentration of other elements (e.g., solutes) in the carrier, the pressure within the chamber, the chemistry of the carrier and the active agent, combinations thereof, and the like. Such factors may be selected/controlled such that execution of the agent loading process results in the formation of surface treatment liquid that contains more than a threshold concentration of surface treatment agent(s) for a desired minimum residence time.

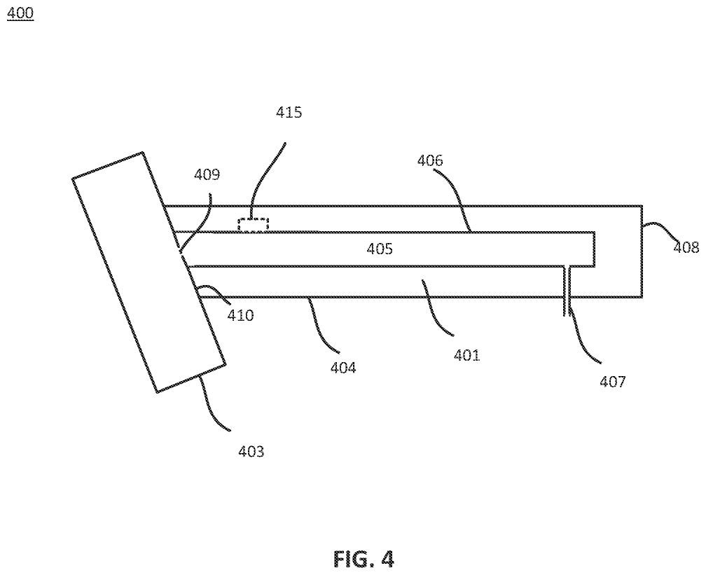

In embodiments the surface treatment article is a device that includes a body with a reservoir (e.g., as discussed below in connection with FIG. 4). In such instances the agent loading process may involve pre-loading the reservoir with a carrier (e.g., water), fluidly connecting an inlet to the reservoir to a source of a sanitizing gas (e.g., an ozone generator), and introducing a sanitizing gas (e.g., ozone) into the liquid reservoir at least in part via the inlet. For example, sanitizing gas may be introduced into the reservoir such that it bubbles into and/or through the carrier. Alternatively, or additionally, the sanitizing gas may be introduced over a surface of a carrier within the reservoir. In alternative embodiments, the agent loading process may involve exposing a carrier to a sanitizing gas prior to loading the carrier into the reservoir, and then introducing the resulting surface treatment liquid into the reservoir. The concentration of surface treatment agent(s) in the surface treatment liquid may depend on various factors, such as the length of the agent loading process, the concentration of the sanitizing gas introduced into the inlet port, the amount of carrier within the reservoir, the solubility of the sanitizing gas within the carrier liquid, the concentration of other elements (e.g., solutes) in the carrier, the pressure within the chamber, the chemistry of the carrier and the active agent, combinations thereof, and the like. Such factors may be controlled such that execution of the agent loading process results in the formation of a surface treatment liquid that contains more than a threshold concentration of surface treatment agent for a desired minimum residence time.

As used herein the term “threshold concentration” refers to a concentration of active agent(s) within a surface treatment liquid. The threshold concentration is preferably selected such that application of the surface treatment liquid to a surface results in efficacious treatment (e.g., disinfection, cleaning, and/or polishing) of the surface. The threshold concentration may differ depending on the nature of the active agent(s) in the surface treatment liquid. In embodiments the active agent is or includes ozone, decomposition products of ozone, and/or reaction products of ozone, and the threshold concentration (in parts per million (ppm) surface treatment agent in surface treatment liquid) is ≥about 0.03 ppm, such as ≥0.05 ppm ≥about 0.1 ppm, ≥about 0.15 ppm, ≥about 0.2 ppm, ≥about 0.25 ppm, ≥about 0.3 ppm, ≥about 0.35 ppm, ≥about 0.4 ppm, ≥about 0.45 ppm, ≥about 0.5 ppm, or more. Without limitation, in embodiments the threshold concentration of surface treatment agent is selected such that a desired disinfection level is achieved when a surface treatment liquid containing the surface treatment agent is applied to a surface, such as a greater than or equal to a log 2, log 3, or even a log 4 reduction in bacteria is achieved when the surface treatment liquid is applied to a surface.

As used herein, the term “residence time” refers to a minimum amount of time that the concentration of a surface treatment agent within a surface treatment liquid remains at or above the threshold concentration following performance of a loading operation consistent with the present disclosure. In embodiments the surface treatment liquids described herein have a minimum residence time of ≥about 30 seconds, ≥about 60 seconds, ≥about 120 seconds, ≥about 180 seconds, ≥about 240 seconds, ≥about 300 seconds (i.e., about 5 minutes), ≥600 seconds (i.e., about 10 minutes), ≥1200 seconds (i.e., about 20 minutes), ≥1800 seconds (i.e., about 30 minutes) or more.

In embodiments the surface treatment liquid is or includes a includes a mixture or solution of a carrier and one or more active agents, wherein the carrier is water, the one or more active agents include ozone, ozone decomposition products with water, ozone reaction products with water, and/or ozone reaction products with solutes in the water, and the threshold concentration and minimum residence time of the one or more active agents is within the above ranges. In specific embodiments, the surface treatment liquid includes water as a carrier and dissolved ozone as an active agent, wherein the threshold concentration of the dissolved ozone is greater than or equal to about 0.03 ppm (e.g., ≥0.05 ppm, ≥about 0.15 ppm, ≥about 0.2 ppm, ≥about 0.25 ppm, ≥about 0.3 ppm, or more), and the minimum residence time of the dissolved ozone is ≥about 60 seconds (e.g., ≥about 120 seconds, ≥about 180 seconds, ≥about 240 seconds, ≥about 300 seconds (i.e., about 5 minutes), etc.), ≥600 seconds (i.e., about 10 minutes), or even ≥1200 seconds (i.e., about 20 minutes) or more.

Following an agent loading process the surface treatment articles described herein may be in a “loaded condition.” In the loaded condition the surface treatment article contains a threshold volume of surface treatment liquid, and the concentration of active agent(s) in the surface treatment liquid exceed a desired minimum threshold amount for a desired minimum residence time. The threshold volume may be any suitable volume for a desired application, and may depend on various factors such as the surface area of the substrate (when the surface treatment article includes a substrate in the form of a cloth) or the volume of a reservoir for containing the surface treatment liquid (when the surface treatment article includes a reservoir). In embodiments the threshold volume ranges from greater than 0 to about 1000 milliliters (ml) or more, such as from greater than 0 to about 500 ml, greater than 0 to about 400 ml, or even greater than 0 to about 250 ml.

It is well understood in the art that ozone is a relatively unstable molecule that will naturally convert to oxygen over time under standard temperature and pressure conditions. The conversion of ozone to oxygen may be facilitated by contacting ozone with a conversion media such as activated carbon, magnesium oxide, magnesium dioxide, manganese dioxide, zeolite, or a combination thereof. In embodiments and as noted above, the surface treatment articles described herein are configured such that following a loading process, the surface treatment articles are in a loaded condition. When the active agent is or includes ozone dissolved in a carrier either alone or in combination with ozone reaction products and/or ozone decomposition products) the concentration of the active agent in the surface treatment liquid will decrease following the agent loading process as ozone naturally converts to oxygen, decomposes, and/or reacts. The volume of surface treatment liquid within the surface treatment article will also decrease as the surface treatment article is used to apply surface treatment liquid to a surface. Eventually, the concentration of active agent(s) ozone within the surface treatment liquid will fall below the threshold concentration, and/or the volume of surface treatment liquid will fall below the threshold volume. When either or both of those conditions is present, the surface treatment article may be in an “unloaded” condition. An unloaded surface treatment article may be reloaded with a surface treatment liquid as described above. For example, an agent loading process as described above may be performed on an unloaded surface treatment article, e.g., after the substrate and/or reservoir of the article is reloaded with a carrier.

One advantage of the surface treatment articles described herein is that they may be repeatedly reloaded with a surface treatment liquid that can be created from readily available materials. Specifically, in instances where the surface treatment liquid contains water as a carrier liquid and ozone (or ozone decomposition/reaction products) as an active agent, the surface treatment liquid may be formed by exposing the carrier (either alone or loaded in a substrate or a reservoir) to gaseous ozone as described above. Thus, users can conveniently reload the surface treatment articles described herein with surface treatment liquid without needing to purchase chemicals. Due to their reusable nature, the surface treatment articles described may produce little waste compared to that produced by other surface treatment products, and particularly disinfecting wipes. Finally, because the surface treatment liquid can be a simple mixture or solution of water and ozone (either alone or with reaction/degradation products of ozone), it presents little or no risk to the environment—particularly as ozone will naturally convert to oxygen under standard temperature and pressure conditions.

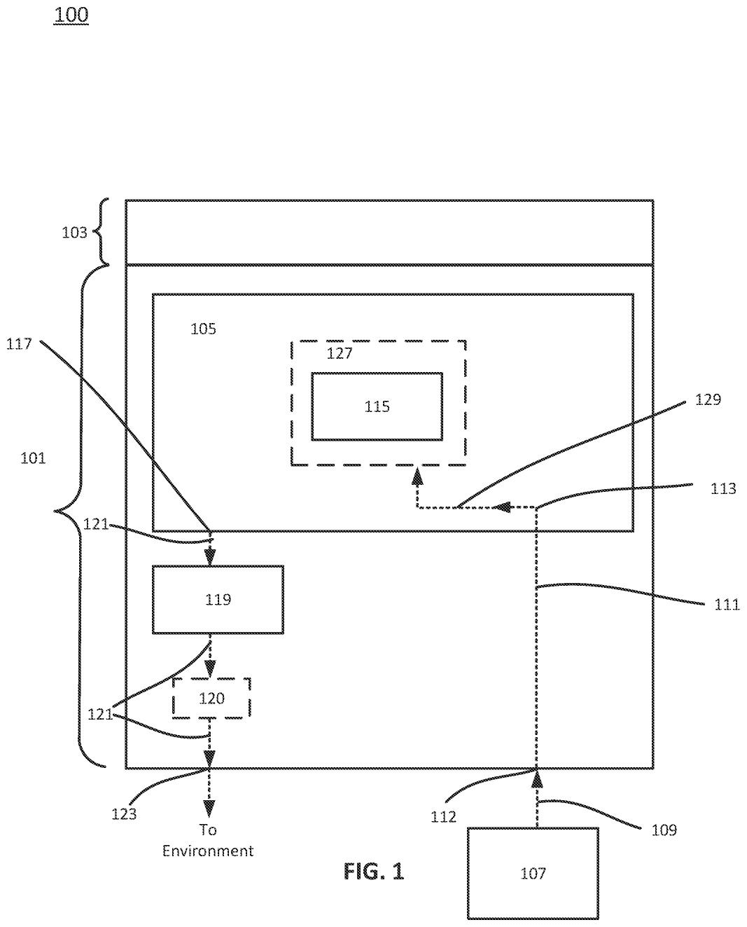

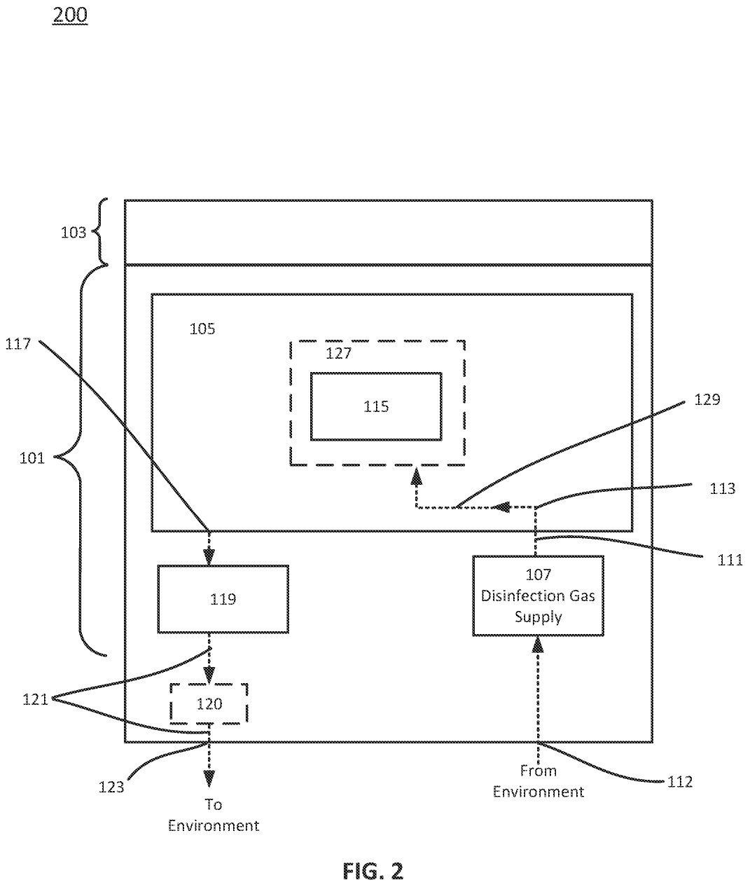

FIGS. 1 and 2 depict examples of a system for producing a loaded surface treatment article consistent with the present disclosure. As shown, systems 100 and 200 include a base 101 and an access port 103. The base 101 includes a chamber 105. In this embodiment access port 103 is in the form of a lid that is movable (e.g., by pivoting or rotating relative to base 101) between a closed position in which access to chamber 105 is blocked, and an open position in which chamber 105 is accessible. Access port 103 need not be in the form of a lid, however, and any suitable access port can be used such. For example, base 101 may be in the form of a resealable bag, in which case access port 103 may be a zipper, a press-seal, combinations thereof, and the like. In embodiments base 101 is or includes a hard sided container and access port 103 is in the form of a valve or door that can be opened and closed to permit or prevent access to chamber 105. Preferably, access port 103 is configured to form a gas tight seal, e.g., with a surface of base 101, to prevent leakage of a sanitizing gas that is used during a loading process.

Chamber 105 is an internal cavity that is disposed within a housing of base 101. In the embodiments of FIGS. 1 and 2, chamber 105 has a plurality of sides, a bottom, and top (not labeled). In some embodiments, the sides and bottom of chamber 105 may be disposed within base 101, and the top of chamber 105 may be defined at least in part by access port 103 when access port 103 is in a closed condition. Such a configuration is not required, however, and chamber 105 may have any suitable configuration. Alternatively, base 101 may be in the form of a resealable bag. In such instances chamber 105 may be an internal cavity that is defined by one or more internal sides of the bag which may be accessed via access port 103 (e.g., a zipper, a press-fit seal, combinations thereof, and the like).

Chamber 105 is configured to fluidly couple to a sanitizing gas supply 107. For example, sanitizing gas supply 107 may be configured to fluidly couple to a proximal end of an inlet 112 of base 101 either directly or via distribution line 109. The distal end of the inlet may fluidly couple to a proximal end of conveyance line 111 that is located within base 101. A distal end of conveyance line 111 may be in fluid communication with an interior of chamber 105. In embodiments the distal end of conveyance line 111 terminates within the interior of chamber 105, as generally shown in FIG. 1. Conveyance line 111 may also include one or more optional bends 113, which may facilitate the distribution of a sanitizing gas within chamber 105, connection with a surface treatment article 115, and/or connection with a stand 127 or another accessory within chamber 105.

In embodiments, conveyance line 111 includes a bend 113 within chamber 105. The bend 113 may extend at an angle A relative to the bottom of chamber 105, wherein angle A ranges from greater than 0 to 180 degrees. In embodiments, bend 113 is configured such that a distal end of conveyance line 111 is parallel or substantially parallel with the bottom of chamber 105. As used herein, “substantially parallel” when used regarding the orientation of a first surface/object to a second surface/object, means that the orientation of the first surface/object within +/−5 degrees of parallel with the orientation of the second surface/object.

Chamber 105 is generally configured to house one or more (loaded or unloaded) surface treatment articles therein when access port 103 is in a closed position. In embodiments chamber 105 is configured to house a plurality of (e.g., ≥2, ≥3, ≥4, ≥5 or more) of surface treatment articles when access port 103 is in a closed position. The size and geometry of chamber 105 is generally not limited, provided it can contain at least one surface treatment article when access port 103 is in a closed condition.

sanitizing gas supply 107 may be any device or system that is configured to supply a sanitizing gas for use in loading a surface treatment article with an active agent consistent with the present disclosure. In embodiments sanitizing gas supply 107 is or includes a source of ozone gas. In embodiments, sanitizing gas supply 107 is an ozone generator that is configured to generate ozone gas, e.g., from air. In such instances the ozone generator may include an inlet and an outlet (both not shown), wherein the inlet is fluidly coupled to a source of air and the outlet is fluidly coupled to chamber 105 as explained above. During a loading process the ozone generator may produce ozone gas from air via corona discharge or another known process, and output ozone gas into the distribution line 109. The sanitizing gas supply 107 may include a fan or pump that is configured to cause a sanitizing gas to flow through into chamber 105, e.g., via distribution line 109 and conveyance line 111. Alternatively or additionally, base 101 may include a fan/pump that is separate from sanitizing gas supply 107, and which is configured to draw the sanitizing gas provided by sanitizing gas supply 107 into chamber 105 during a loading process. Alternatively, in some embodiments distribution line 109 is omitted and sanitizing gas supply 107 is configured to couple (e.g., directly) to conveyance line 111 or a fitting that is coupled to inlet 112 of conveyance line 111.

FIG. 1 depicts an embodiment in which sanitizing gas supply 107 is located outside of base 101. Such a configuration may be useful in various instances, such as when it is desired to physically separate the sanitizing gas supply 107 from base 101. Such a configuration is not required, however, and system 100 may be configured in another manner. This is demonstrated by system 200 shown in FIG. 2, which is identical to system 100 except that it includes a sanitizing gas supply 107 within base 101 and downstream of inlet 112. In the embodiment of FIG. 2, inlet 112 may be configured to fluidly couple sanitizing gas supply 107 with a source of air, particularly when sanitizing gas supply 107 is or includes an ozone generator that is configured to generate ozone from air.

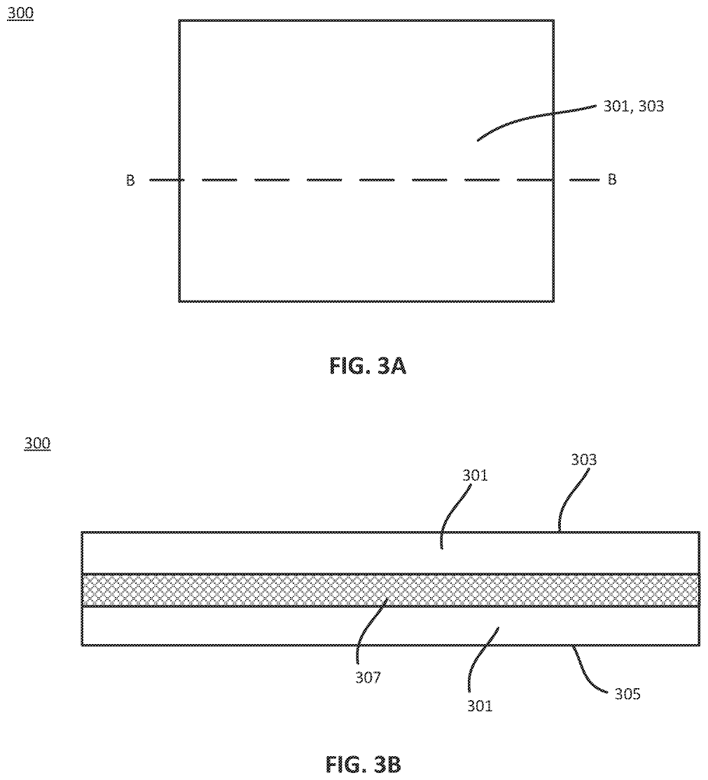

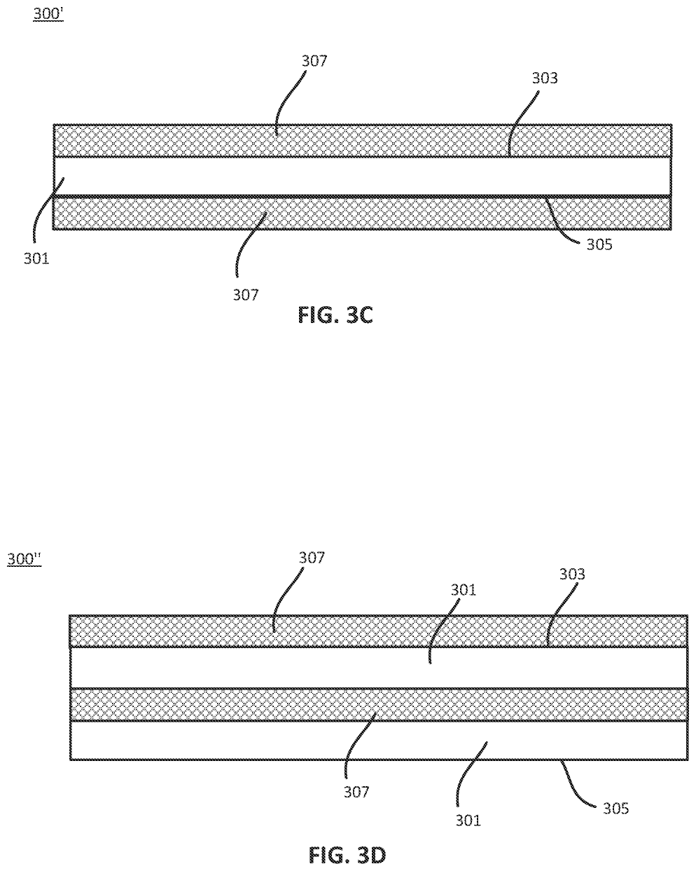

In some embodiments the surface treatment article 115 includes a substrate in the form of a flexible sheet or cloth (e.g., a microfiber cloth, cotton cloth, or the like). In other embodiments, however, surface treatment article 115 is in the form of a device that includes a reservoir for containing surface treatment liquid, and a head for dispensing the surface treatment liquid, e.g., on a surface to be treated. Further details concerning surface treatment article 115 are provided later in connection with FIGS. 3A-3D and 4.

Chamber 105 includes or is fluidly coupled to an exhaust port 117. The exhaust port 117 may have any suitable shape, and in embodiments includes or is in the form of one or more openings that are formed through a wall (e.g., a side, a bottom, a top, combinations thereof, etc.) of the chamber 105. In specific non-limiting embodiments, the exhaust port 117 is in the form of one or a plurality (e.g., greater than or equal to 2, 3, 4, 5, 10, or more) openings through a wall (e.g., a side, a bottom, or a combination thereof) of the chamber 105. Such openings may have any suitable shape. In embodiments the exhaust port includes a plurality of geometric (e.g., circular, triangular, quadrilateral, oval, elliptical, etc.) openings, irregular shaped openings, or a combination thereof. Regardless of their shape, the exhaust port 117 is configured to convey an unfiltered exhaust stream that contains sanitizing gas (e.g., ozone) used during an agent loading out of chamber 105 and to one or more downstream components as described below.

Systems 100, 200 further include a filter 119 that is positioned downstream of the exhaust port 117. The filter 119 may be configured to receive the unfiltered exhaust stream in any suitable manner. For example, the filter 119 may be configured to fluidly couple to the exhaust port 117, either directly or through an optional exhaust channel 121 between exhaust port 117 and filter 119 (not shown). In embodiments the filter 119 includes a filter inlet and a filter outlet, wherein the filter inlet is configured to couple directly to the exhaust port 117. Alternatively, an optional exhaust channel 121 is present and is configured to provide at least a portion of a flow path between exhaust port 117 and filter 119. For example, the optional exhaust channel 121 may include a passage with a proximal end and a distal end, wherein the proximal end is configured to fluidly (or directly) couple to the exhaust port 117, and the distal end is configured to fluidly (or directly) couple to the filter inlet of filter 119.

Filter 119 may be configured in any suitable manner and may be integral with or removable from system 100, 200 and, more particularly, with base 101. In embodiments filter 119 is in the form of a filter cartridge that is configured to be installed and removed system 100, 200, and more particularly from base 101. The filter cartridge may include a filter housing and a filter media in the filter housing. Consistent with the foregoing discussion, the filter housing may include a filter inlet and a filter outlet and may be configured such that the filter inlet fluidly (or directly) couples with the exhaust port 117 when it is installed within system 100, 200.

While FIGS. 1 and 2 show embodiments in which a filter 119 is within base 101, such a configuration is not required, and the systems described herein may be configured such that filter 119 is in a different location. For example, the systems may be configured such that filter 119 is in access port 103 (e.g., a lid), within one or more sidewalls of the chamber 105, within chamber 105, combinations thereof, and the like.

In general, filter 119 (or, more specifically, a filter media therein) is configured to reduce the amount of sanitizing gas within the unfiltered exhaust stream and to produce a filtered exhaust stream. More specifically, filter 119 may be configured to receive an unfiltered exhaust stream that contains a first amount of sanitizing gas and produce a filtered exhaust stream that contains a second amount of sanitizing gas that is less than the first amount of sanitizing gas. In embodiments the first amount of sanitizing gas (e.g., ozone) may be greater than or equal to about 50 parts per million (ppm), e.g., greater than or equal to about 100 ppm, about 150 ppm, about 200 ppm, about 250 ppm, about 300 ppm, 350 ppm, about 400 ppm and even greater than or equal to 450 ppm. In those or other embodiments the second amount of sanitizing gas (e.g., ozone) may be less than 50 ppm, such as less than about 25 ppm, less than about 10 ppm, less than about 5 ppm, less than about 1 ppm, less than about 0.5 ppm, or even less than about 0.05 ppm. In specific non-limiting embodiments, the second amount of sanitizing gas may be 0. Put differently, the filter 119 may reduce the amount of sanitizing gas in the unfiltered exhaust stream by at least about 50%, e.g., at least about 60%, at least about 70%, at least about 80%, at least about 90%, at least about 95%, at least about 99%, at least about 99.9%, or even 100%.

Filter 119 may reduce the amount of sanitizing gas in the unfiltered exhaust stream in any suitable manner, such as via absorption of the sanitizing gas, adsorption of the sanitizing gas, conversion of the sanitizing gas, or a combination thereof. In embodiments filter 119 is configured to convert sanitizing gas in the unfiltered exhaust stream to a breathable gas. For example, when the sanitizing gas is or includes ozone, filter 119 may include a conversion media that is configured to convert at least a portion of the ozone in the unfiltered exhaust stream to oxygen. Non-limiting examples of materials that may be used as such filter media include activated carbon, magnesium oxide, magnesium dioxide, manganese dioxide, zeolite, combinations thereof or the like, all of which can facilitate the conversion of ozone to oxygen.

Systems 100, 200 further include a discharge outlet 123 that is configured to receive the filtered exhaust stream produced by filter 119 in any suitable manner. For example, discharge outlet 123 may be fluidly coupled to filter 119, e.g., by an exhaust channel 121. In operation, the filtered exhaust stream produced by filter 119 may flow through the exhaust channel 121 and through discharge outlet 123. In embodiments, such flow may be facilitated by an optional fan/pump 120 located downstream of filter 119, and which is configured to blow or draw the filtered exhaust stream out of discharge outlet 123.

Discharge outlet 123 may be fluidly coupled to the filter 119 in any suitable manner. For example, the discharge outlet may be fluidly coupled to the fan 120 and discharge the filtered exhaust stream, e.g., into the environment surrounding systems 100, 200. In the embodiment of FIG. 1 the discharge outlet 123 is fluidly coupled (e.g., directly or indirectly) with and located downstream of the fan 120. In the embodiment of FIG. 2, the discharge outlet 123 is fluidly coupled with and located downstream of the filter 119.

When used, optional fan 120 may be configured to draw the sanitizing gas from chamber 105, through exhaust port 117, and into filter 119. In addition, optional fan 120 may draw the filtered exhaust stream from filter 119 and facilitate its conveyance through discharge outlet 123. In embodiments systems 100, 200 include optional fan 120. In such embodiments optional fan 120 may be configured to run at a variable (e.g., programmable) rate, e.g., to regulate the flow of sanitizing gas into and out of chamber 105. For example, fan 120 may be run at a first (relatively slow) rate, which causes sanitizing gas (e.g., ozone) to flow into chamber 105 at first (relatively slow) inlet flow rate, and in turn causes gas (e.g., air mixed with ozone) to flow out of chamber 105 at a first (relatively slow) outlet flow rate. Similarly, fan 120 may be run at a second (relatively fast) flow rate which causes sanitizing gas (e.g., ozone) to flow into chamber 105 at second (relatively slow) inlet flow rate (which is faster than the first inlet flow rate), and in turn causes gas (e.g., air mixed with ozone) to flow out of chamber 105 at a second (relatively slow) outlet flow rate (which is faster than the second outlet flow rate. As may be appreciated, by controlling the duty level of optional fan 120, one may control the rate at which sanitizing gas flows into and out of chamber 105, and thus the amount of time sanitizing gas is resident within chamber 105. Likewise, by controlling the duty level of fan 120, one may control the concentration of active agent that is loaded into surface treatment article 115 (or, more particularly, a carrier thereof) during an agent loading process, and/or the rate at which the active agent is loaded in an agent loading process.

For the sake of brevity and ease of understanding, FIGS. 1 and 2 have been described generally with a focus on certain components. As would be understood by one of ordinary skill in the art, the systems described herein may be configured differently. In that regard reference is made to U.S. Provisional Application 63/087,047 (filed Oct. 2, 2020 and titled Disinfection Devices and Methods Using the Same—hereafter, the “'047 application”), U.S. application Ser. No. 17/490,887 (filed Sep. 30, 2021 and titled “Disinfection Devices and Methods Using the Same”—hereafter the '887 application), U.S. application Ser. No. 17/013,198 (filed Sep. 4, 2020 and titled “Device Disinfector”—hereafter, “the '198 application”), and U.S. Provisional Application No. 63/038,573 (filed Jun. 12, 2020 and titled “Sanitization Device”—hereinafter, “the '573 application”) the entire content of all of which are incorporated herein by reference. Reference is particularly made to the devices disclosed in the '198 and '593 applications, and the devices disclosed in the '047 and '887 applications, any of which can be used to produce/load surface treatment articles consistent with the present disclosure. Even more particularly, reference is made to the devices shown and described in connection with FIGS. 1-17 of the '198 and '593 applications, and FIGS. 1-4 and 6A-7B of the '047 and '887 applications, which may be used to produce/load surface treatment articles consistent with the present disclosure.

FIGS. 3A and 3B depict example of a surface treatment article 300 that may be used as surface treatment article 115 in systems 100, 200. As shown, surface treatment article 300 includes a substrate 301 having a first surface 303 and a second surface 305 that is opposite or substantially opposite first surface 303. Substrate 301 may be formed from any material that can be adequately loaded with surface treatment liquid. In embodiments the substrate 301 is a sponge or a woven or non-woven cloth that is made of natural or synthetic material such as but not limited to natural fibers, synthetic fibers, or a combination thereof. Non-limiting examples of natural fibers that may be used in substrate 301 include cotton, flax, hemp, jute, wool, silk, wool, angora, camel hair, bamboo, cellulose, combinations thereof, and the like. Non-limiting examples of suitable synthetic fibers that may be used in substrate 301 include Rayon, polyamide (Nylon), polyester fibers, acrylic fibers, acetate fibers, combinations thereof, and the like. In embodiments substrate 301 is a microfiber cloth, a cotton cloth, or a combination thereof. In any case, substrate 301 may be configured such that it can be loaded with a carrier as described above, e.g., by absorbing, adsorbing, and/or being wetted by a threshold volume of a carrier.

Substrate 301 may be used alone, or it may include one or more layers. As shown in FIG. 3B (which is a cross section of FIG. 3A through plane B), surface treatment article 300 may optionally include a layer 307 between two layers/regions of substrate 301. In general, layer 307 is configured to retain a carrier and/or a surface treatment liquid, e.g., by absorption, adsorption, or the like. In embodiments, layer 307 is an absorbent layer that is configured to absorb a carrier and/or a surface treatment liquid, thereby increasing the amount of carrier/surface treatment liquid that may be contained by surface treatment article 300, relative to the use of substrate 301 alone. In embodiments the carrier is or includes water, and layer 307 is formed from or includes a water absorbent material. Non-limiting examples of suitable water absorbent materials that may be used as or in layer 307 include hydrophilic polymers, hydrophilic woven and non-woven fabrics, modal fabric, combinations thereof, and the like. Without limitation, in embodiments substrate 301 and optional layer 307 are configured to absorb at least a threshold amount of carrier/surface treatment liquid, and to release at least a portion of the surface treatment liquid, e.g., when surface treatment article 300 is subject to pressure (e.g., by wiping on a surface).

The surface treatment articles described herein may also include a substrate in combination with a plurality of layers. In that regard reference is made to FIGS. 3C and 3D, which are cross sections of a surface treatment article along plane B shown in FIG. 3A, and which depict additional non-limiting examples of surface treatment articles consistent with the present disclosure. As shown in FIG. 3C, a surface treatment article 300′ may include a single region of substrate 301 that includes a first surface 303 and a second surface 305, wherein a (first) layer 307 is on the first surface 303, and a (second) layer 307 is on the second surface 305. Alternatively, and as shown in FIG. 3D, a surface treatment article 300″ may include two regions of substrate 301, a (first) layer 307 between the first and second regions of substrate 301, and a second layer 307 on a first surface of one of the regions of substrate 301. Additional configurations are also possible. For example, the surface treatment articles described herein could be configured in the same manner as shown in FIG. 3D, with a layer 307 on a second surface 305 instead of or in addition to a layer 307 on first surface 303. Layers 307 in FIGS. 3C and 3D may be configured in the same manner as layer 307 in article 300 described above in connection with FIG. 3B, and so are not redescribed in detail.

Returning to FIGS. 1 and 2, to perform an agent loading operation a surface treatment article consistent with the present disclosure may be placed within chamber 105. In embodiments, the surface treatment article is or includes a substrate wetted with a carrier before it is placed within chamber 105. For example, when the carrier liquid is water and the substrate is a cloth, the cloth may be wetted with water (e.g., to a drip dry state) prior to being placed within chamber 105. Access port 103 may then be moved to the closed position, whereupon it forms a gas tight seal that closes chamber 105. A controller (not shown) may then cause sanitizing gas supply 107 to provide a sanitizing gas to chamber 105. In embodiments the sanitizing gas is ozone gas and sanitizing gas supply 107 is configured to supply ozone gas in any suitable manner. In embodiments, the controller causes sanitizing gas supply 107 to generate ozone gas from air.

In any case, sanitizing gas flows from sanitizing gas supply 107 through inlet 112 (directly or at least in part via distribution line 109) and through conveyance line 111. In embodiments, the sanitizing gas is ozone and the distal end of conveyance line 111 is fluidly coupled to the interior of chamber 105. In such instances, the sanitizing gas disperses within chamber 105 once it exits the distal end of conveyance line 111. Over time, the concentration of the sanitizing gas within chamber 105 will increase to a desired chamber concentration. In embodiments, the chamber concentration ranges from greater than 0 to about 500 parts per million (ppm), such as about 1 ppm to about 500 ppm, about 5 to about 500 ppm, about 10 to about 400 ppm, about 50 to about 50 to about 300 ppm, or even about 100 to about 300 ppm. In embodiments, the chamber concentration of sanitizing gas is about 100 to about 200 ppm, such as about 150 to about 200 ppm. In specific non-limiting embodiments, the sanitizing gas is ozone gas and the chamber concentration is within the above described limits during at least part of an agent loading operation.

In embodiments, during the agent loading operation the sanitizing gas may flow around and contact the surface treatment article within chamber 105. More particularly, the sanitizing gas contacts the carrier that is loaded or otherwise contained within substrate 301 and/or optional layer(s) 307 of the surface treatment article. Alternatively, when the surface treatment article is a device that includes a reservoir, sanitizing gas may be directed into the reservoir to contain the carrier therein. Contact between the carrier and the sanitizing gas results in the carrier becoming loaded with one or more active agents as described above. For example, when the sanitizing gas is ozone, contact between ozone and the carrier causes the carrier to become loaded with active agents such as dissolved ozone, ozone degradation products, and/or ozone reaction products. As the agent loading process continues, the concentration of active agent(s) within the carrier increases over time. The agent loading process may continue for a sufficient time to allow the concentration of active agent in the carrier to reach or exceed a desired threshold concentration as described above.

Once the threshold concentration has been met or exceeded, the controller may cause an exhaust process to be executed. During the exhaust process the controller may cause surface sanitizing gas supply 107 to cease providing sanitizing gas to chamber 105. Sanitizing gas remaining in chamber 105 may be removed in any suitable manner, such as via exhaust port 117 and optional fan 120. For example, systems 100, 200 may be configured such that when access port 103 is moved to the open position, sanitizing gas within chamber 105 is rapidly exhausted through exhaust port 117 and filter 119, e.g., in the manner described in U.S. Provisional Application 63/087,047 and U.S. application Ser. No. 17/490,887 (which are incorporated herein by reference) in connection with the rapid evacuation of ozone gas from a chamber. In that way a user may rapidly gain access to surface treatment article 115 once the loading process is complete. Notably, in instances where ozone is the sanitizing gas, this can allow a user to access the surface treatment article before a significant amount of ozone within the surface treatment liquid converts to oxygen as previously described.

A surface treatment article may be placed at any location within chamber 105 prior to execution of an agent loading operation. While placing the surface treatment article in any manner in chamber 105 can be effective, certain placements may cause portions of surface treatment article to be obscured, e.g., by one or more walls or the bottom of chamber 105 or by overlapping portions of the article itself. This may limit contact between the sanitizing gas and the carrier within the surface treatment article during an agent loading operation, leading to uneven or incomplete loading of active agent(s) into the surface treatment article. To address this issue and as shown in FIGS. 1 and 2, systems 100, 200 may optionally include a stand 127 that is configured to support surface treatment article 115/300 during a loading operation. In general, stand 127 may include one or more features that are configured to support a surface treatment article during a loading process. The stand 127 may also be configured to increase the amount of surface area of the surface treatment article that is exposed to the sanitizing gas during an agent loading process. The stand 127 may perform that function by limiting or preventing portions of surface treatment article from folding or overlapping with one another, e.g., by limiting or preventing contact between surface treatment article 115/300 and one of more walls of chamber 105.

The physical configuration of stand 127 is not limited, and any suitable stand may be used. In embodiments, stand 127 is in the form of a sanitization accessory, spacer, or rack, such as those illustrated and described in U.S. application Ser. No. 17/013,198 (filed Sep. 4, 2020, and titled “Device Disinfector”) and U.S. Provisional Application No. 63/038,573 (filed Jun. 12, 2020 and titled “Sanitization Device”), which are again incorporated herein by reference. Attention is particularly drawn to the sanitization accessories, spacers, and racks illustrated in accordance with FIGS. 28-40 and 48-51 of the '198 application and FIGS. 23-26 of the '573 application and the corresponding descriptions thereof, as any of such accessories, spacers, and racks may be used as stand 127.

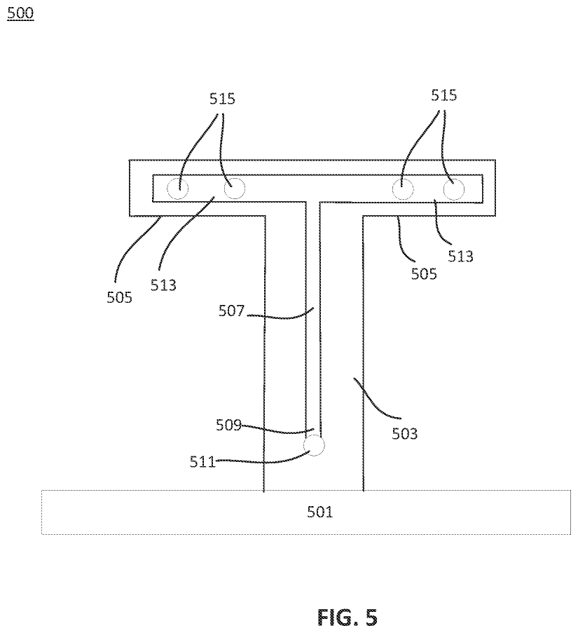

FIG. 5 depicts another example of a stand that may be used as stand 127 in the systems of FIGS. 1 and 2. As shown, stand 500 includes a stand base 501, a stand body 503, and at least one arm 505 extending from the stand body 503. The stand 500 further includes a flow channel 507. The flow channel 507 includes a proximal end 509 that is fluidly coupled to an inlet 511, and at least one distal end 513 that is coupled to at least one outlet 515. For the sake of illustration FIG. 5 shows inlet 511 as having a generally circular cross section and as being disposed on stand body 503, but inlet 511 may be configured and located differently. For example, inlet 511 may have any suitable shape, and may be located on stand base 501, one or more of arms 505, or a combination thereof. Multiple inlets 511 may also be used. Similarly, the shape, location, and number of outlets 515 are not limited to illustration of FIG. 5. Like inlet 511, outlets 515 may have any suitable shape, and may be positioned at any suitable location (e.g., on stand base 501, stand body 503, etc.), with a corresponding change in flow channel 507. Flow channel 507 may also be configured differently than the illustration of FIG. 5. For example, in embodiments at least a portion of flow channel 507 may extend outside of stand base 501, stand body 503, and/or arms 505. A plurality of flow channels (with a corresponding number of inlets and outlets) may also be used. Alternatively, flow channel 507 may be omitted.

During an agent loading operation, the stand 127/500 may be fluidly connected to the sanitizing gas supply 107 via optional connector 129, conveyance line 111, and/or distribution line 109. A controller may cause the sanitizing gas supply 107 to provide a sanitizing gas (e.g., ozone gas) as noted above. The sanitizing gas provided by sanitizing gas supply 107 may flow into the proximal end of the flow channel 507 within stand 500, through flow channel the internal passageway, and through the at least one outlet 515 located on at least one arm of the stand 127. As a result, the sanitizing gas will be introduced into the chamber 105 underneath the surface treatment article 115. Introducing the sanitizing gas in that manner may enhance contact between the sanitizing gas and the carrier of the surface treatment article 115, potentially reducing the amount of time needed for the concentration of sanitizing gas in the carrier to reach a desired threshold concentration.

FIG. 4 depicts another example of a surface treatment device consistent with the present disclosure, and which may be used as surface treatment article 115. As shown, surface treatment device 400 includes a body 401 and a head 403. The body includes a reservoir 405 for containing a surface treatment liquid, such as the surface treatment liquids described above. In this embodiment the body 401 has an elongated shape with an outer wall 404, a proximal end 408, and a distal end 410. In such a configuration, body 401 may generally function as a handle that can be grasped by a user. The shape of body 401 is not limited, however, and body 401 may have any suitable shape. For example, body 401 may have a circular, ellipsoidal, quadrilateral (square, rectangle, etc.), pentagonal, hexagonal, or irregular shape and/or cross section.

Body 401 may be formed from any suitable material. In embodiments, body 401 includes or is formed from a substantially rigid material that is resistant to degradation by a surface treatment liquid that is to be contained within reservoir 405. Non-limiting examples of materials that may be used to form body 401 include metals (e.g., aluminum), alloys (e.g., steel), polymers, combinations thereof, and the like. In embodiments, body 401 is formed from or includes one or more ozone resistant polymers, such as but not limited to poly ether ether ketone (PEEK), polycarbonate, polyvinyl chloride, chlorinated polyvinyl chloride, polyvinylidene difluoride (PVDF), polytetrafluoroethylene (PTFE), acrylonitrile butadiene styrene (ABS), polyethylene, combinations thereof, and the like.

In the embodiment of FIG. 4, reservoir 405 is a cavity that is disposed within body 401, and is at least partially defined by an inner wall 406 of body 401. Moreover, reservoir 405 is illustrated as having an elongate shape that extends generally from the distal end 410 towards the proximal end 408. While the illustrated configuration is suitable, reservoir 405 is not limited thereto and may be configured in any suitable manner. For example, reservoir 405 may be located outside of body 401 and coupled directly or indirectly to outer wall 404. Similarly, reservoir 405 may be located inside or outside of head 403.

Regardless of its configuration, reservoir 405 includes a port/inlet 407 and an outlet 409. The port/inlet 407 generally functions as an inlet for the introduction of a carrier liquid, surface treatment agent, and/or a pre-made surface treatment liquid into reservoir 405. In that regard, port/inlet 407 includes a fluid passageway that is fluidly coupled to the reservoir 405, such that that fluid introduced into port/inlet 407 can flow into reservoir 405.

The size of reservoir 405 is not limited, and any suitable size reservoir may be used. In embodiments, reservoir 405 is configured to contain a sufficient volume of surface treatment liquid for one or more disinfection tasks. In embodiments, the volume of reservoir 405 ranges from greater than 0 to about 500 milliliters (ml), such as greater than 0 to about 400 ml, ≥about 25 to about 300 ml, or even ≥about 50 ml to about 250 ml. Larger or smaller reservoirs may also be used.

In addition to storing surface treatment liquid, reservoir 405 is configured to convey surface treatment liquid to head 403. In that regard reservoir 405 may include an outlet 409 that fluidly couples the reservoir 405 to head 403. In the illustrated embodiment outlet 409 is shown as being formed through an end wall of reservoir 405/body 401, but outlet 409 is not limited to that configuration. In embodiments, outlet 409 includes or is in the form of a valve that can selectively release surface treatment liquid from reservoir 405 into head 403, e.g., in response to an action from a user. For example, outlet 409 may be configured to selectively release surface treatment liquid into head 403 in response to pressure applied to head 403, user interaction with a button, gate, or other structure on body 401 and/or head 403, combinations thereof, and the like. In that way reservoir 405 may retain surface treatment liquid therein without (or without substantial) leakage into head 403 when surface treatment device 400 is not in use.

Head 403 is generally configured to receive surface treatment liquid from reservoir 405 and to dispense surface treatment liquid to a surface to be disinfected. In the illustrated embodiment head 403 is illustrated as having a generally rectangular shape/cross section, but head 403 is not limited thereto. Indeed head 403 may have any suitable shape, such as a circular, ellipsoidal, quadrilateral, pentagonal, hexagonal, etc., another geometric shape, an irregular shape, or a combination thereof. In addition to being of aesthetic interest, such shapes may be useful when head 403 is configured to apply surface treatment liquid by the direct contact of head 403 with a surface to be treated. In such embodiments, head 403 may be in the form of a sponge or other absorbent article that may receive surface treatment liquid from reservoir 405 and dispense that surface treatment liquid onto a surface to be treated, e.g., by wiping and/or application of pressure. In such instances head 403 may be formed from or include a material that is suitable for dispensing surface treatment liquid by physical contact with a surface. Non-limiting examples of such materials include sponge materials, foam materials, woven fabrics, non-woven fabrics, combinations thereof, and the like.

Head 403 need not be configured to dispense surface treatment liquid by physical contact. Indeed, in embodiments, head 403 is configured to dispense surface treatment liquid onto a surface without physical contact between the head 403 and the surface. For example, head 403 may include a nozzle or other device that is configured to dispense surface treatment liquid onto a surface, e.g., by spraying.

A description of how surface treatment device 400 may be loaded with a surface treatment liquid will now be provided with reference to FIGS. 1 and 2. To perform an agent loading operation, a carrier (e.g., water) may be loaded into reservoir 405 via port/inlet 407. Surface treatment device 400 (which may be used as surface treatment article 115) may then be placed within chamber 105, and port/inlet 407 may be fluidly coupled to sanitizing gas supply 107. In some embodiments the port/inlet 407 may be directly coupled to an outlet from sanitizing gas supply 107, or it may be fluidly coupled to sanitizing gas supply 107 via one or more of conveyance line 111 and/or optional connector 129. In embodiments, system 200 includes a conveyance line 111 with a bend (e.g., a right angle bend) 113. In such embodiments, a connector 129 may be used to couple the distal end of the conveyance line (e.g., downstream of bend 113) to surface treatment device 400. In any case, once port/inlet 407 is fluidly coupled to sanitizing gas supply 107, a fluid connection is established between sanitizing gas supply 107 and reservoir 405. The access port 103 may then be moved to the closed position.

Once the access port 103 is closed, a controller (not shown) may cause sanitizing gas supply 107 to provide a surface treatment agent (e.g., ozone gas) into reservoir 405. The sanitizing gas will bubble into the carrier within reservoir 405, causing the carrier to become loaded with one or more active agents as discussed above and forming a surface treatment liquid. Over time, the concentration of active agent(s) within the surface treatment liquid will rise as additional sanitizing gas is introduced into reservoir 405.

As the sanitizing gas is provided the pressure within reservoir 405 will rise. To prevent reservoir 405 from bursting, the controller may determine the pressure within the reservoir in various ways. For example, when the volume of reservoir 405 and flow rate of the sanitizing gas is known, controller may calculate the relative increase in pressure within reservoir 405. Alternatively, controller may determine the pressure within reservoir 405 based on pressure signals sent by one or more pressure sensors (not shown), e.g., within reservoir 405. In any case, controller may compare the determined pressure to a threshold pressure that is less than burst pressure of reservoir 405. In embodiments, the threshold pressure is a pressure is achieved in reservoir 405 when the concentration of active agent(s) in the surface treatment liquid reaches or exceeds a threshold concentration.

Alternatively, surface treatment device 400 may include an optional pressure release valve 415, as shown in FIG. 4. In general, pressure relief valve 415 is configured to remain closed until the pressure within reservoir 405 reaches a threshold pressure, which as noted above is set to a pressure that is lower than the burst pressure of reservoir 405. When the pressure within reservoir 405 reaches the threshold pressure, however, the pressure relief valve 415 may open to reduce the pressure within reservoir 405 to below the threshold pressure. As before, when the volume of reservoir is known, the threshold pressure may be selected to correspond to a pressure at which the concentration of active agent(s) within the surface treatment liquid in reservoir 405 has reached a desired threshold concentration.

Once the threshold pressure is reached (or at some other time), the controller may cause s sanitizing gas supply 107 to cease operation. An exhaust process may then be executed to remove any sanitizing gas that may be present within chamber 105, as described above. Surface treatment device 400 may then be decoupled from sanitizing gas supply 107 and used to treat a surface by application of surface treatment liquid by head 403.

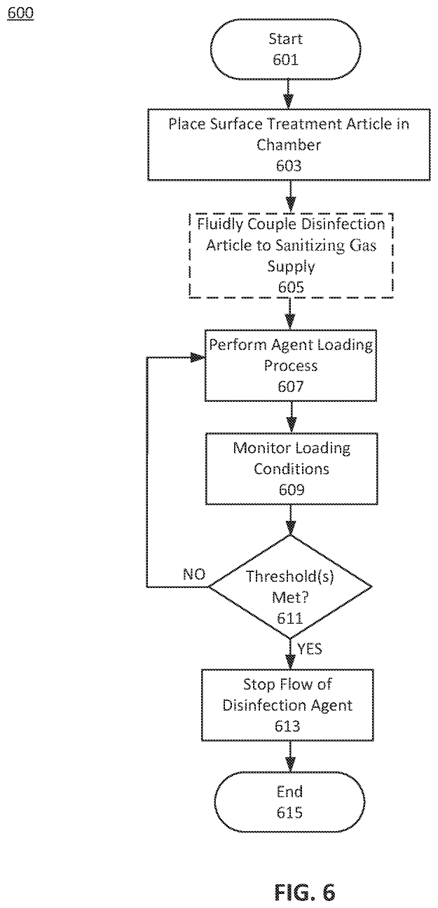

FIG. 6 is a flow diagram illustrating example operations of a method of loading surface treatment articles consistent with the present disclosure. As shown the method 600 begins with block 601. The method may then proceed to block 603, pursuant to which an unloaded surface treatment article may be placed in a chamber of a system consistent with the present disclosure, such as but not limited to chamber 105 discussed above. The unloaded surface treatment article may be loaded with a carrier prior to placement in the chamber as noted above. For example, an unloaded surface treatment article (e.g., a cloth) may be loaded (e.g., to a drip dry state) with a carrier. Alternatively, when the sanitizing article is a device with a reservoir, a reservoir containing an unloaded carrier may be placed in the chamber.

The method may then proceed to optional block 605, pursuant to which the surface treatment article may be fluidly coupled to a surface treatment agent supply, such as surface treatment agent supply 107. This operation may be performed, for example, when the surface treatment article is a surface treatment device that includes a reservoir for containing a surface treatment liquid, such as but not limited to surface treatment device 400. If the unloaded surface treatment article is a cloth or other substrate, the operations of block 605 may be omitted.

Following the operations of block 605 or if such operations are omitted, the method may proceed to block 607, pursuant to which a sanitizing gas may be provided. Provision of the sanitizing gas may be performed in any suitable manner. For example, and as noted above, when the unloaded surface treatment article is in the form of or includes a flexible substrate such as a cloth, the sanitizing gas may be introduced into the chamber such that it can contact the unloaded surface treatment article or, more specifically, the carrier thereof. In embodiments, the sanitizing gas may be supplied at least in part via a flow channel on or within a stand that is used to support the surface treatment article within the chamber. Alternatively, when the surface treatment article includes a body with a reservoir as discussed above in connection with FIG. 4, providing the surface treatment agent may include fluidly coupling an inlet to the reservoir to a sanitizing gas supply and causing the sanitizing gas to flow into the reservoir at least in part via the inlet.

During or after the operations of block 607 the method may proceed to block 609, pursuant to which loading conditions of the surface treatment article may be monitored. Such operations may include monitoring (e.g., with a controller) the volume of surface treatment liquid within the surface treatment article, monitoring the pressure within a reservoir within the surface treatment article, monitoring a concentration of active agent(s) within the surface treatment liquid, etc., combinations thereof, and the like, as described above. Such monitoring may involve comparing (e.g., with a controller) detected/determined conditions to relevant thresholds, such as a threshold volume, threshold concentration, etc., as discussed above. Such thresholds may be set such that they are indicative of whether the surface treatment article is in a loaded or unloaded condition.

The method may then proceed to block 611, pursuant to which a determination may be made (e.g., by a controller) as to whether the threshold loading conditions discussed above are met. If not, the method loops back to block 607. But if so, a determination may be made that the surface treatment article is in a loaded condition. The method may then proceed to block 613—pursuant to which a flow of sanitizing gas is stopped. The method may then proceed to block 615 and end, and the loaded surface treatment article may be retrieved by a user and used to apply surface treatment liquid to a desired surface.

As will be appreciated from the foregoing, Applicant has discovered that surface treatment articles can be prepared by wetting a substrate such as a microfiber cloth or cotton cloth with water to a drip dry state, placing the wetted substrate in a chamber, and introducing a sanitizing gas such as ozone into the chamber, thereby loading the water and substrate with active agents such as dissolved ozone, ozone degradation products, and/or ozone reaction products. Such surface treatment article have been found to exhibit remarkable and unexpected properties, particularly for cleaning, disinfection, and polishing applications. Such articles have been found to exhibits an unexpected combination of good cleaning, disinfection, and polishing properties when the surface treatment article is applied to a surface with a wiping and/or buffing motion. Moreover, the cleaning, disinfection, and polishing properties of such articles are surface agnostic, meaning that desirable results can be achieved on many different surfaces such as wood, stone (e.g., granite, soapstone, concrete, etc.), ceramic (e.g., tile), stainless steel, linoleum, combinations thereof, and the like.

Without wishing to be bound by theory, it is believed that when water (loaded into a substrate or a reservoir) is exposed to ozone gas, at least a portion of the ozone dissolves into the water as dissolved ozone. In addition, it is believed that at least a portion of the ozone decomposes or otherwise converts into hydroxyl (OH) radicals—which are highly oxidizing in nature (E°=2.8V). Thus, when a substrate wetted with water or a reservoir containing water is exposed to ozone gas, it is believed that the water will be loaded with ozone and/or OH radicals. It is believed that both the ozone and OH radicals will oxidize contaminants on a soiled surface—thereby enabling ready removal of such contaminants from the surface with a simple wiping motion of a surface treatment article described herein—resulting in the production of a remarkably clean, streak free and polished surface.

Applicant has also found that the surface treatment articles described herein can exhibit many benefits over existing products. For example, Applicant has discovered that surface treatment articles consistent with the present disclosure can effectively treat (e.g., clean, disinfect, and/or polish) surfaces for a surprisingly long period of time given the tendency of ozone to naturally convert to oxygen over time. Indeed, Applicant has discovered that such Surface treatment articles can be effectively used for at least 10 minutes (e.g., 20 minutes) to clean, polish, and/or disinfect a surface. Without wishing to be bound by theory, it is believed that such ability is due to a surprisingly long residence time of ozone, ozone degradation products, and/or ozone reaction products in a substrate such as a microfiber and/or cotton cloth, which can exceed 10, 15, 20, or even 30 minutes as noted above. After such time (e.g., when the concentration of active agent(s) in the surface treatment article falls below a threshold value), the surface treatment article may be reloaded with active agent(s) by performing an agent loading process as discussed above. Thus, the surface treatment articles described herein can be re-used many times to clean, polish, and/or disinfect surfaces before it needs to be discarded—a notable advantage over single use cleaning wipes.

The Applicant has found also found that surface treatment articles consistent with the present disclosure facilitate the physical removal of impurities from a surface. This is unlike other surface cleaners, which were observed to spread impurities over a surface to be cleaned. As a result, the surface treatment articles described herein—when used to wipe or otherwise apply a surface treatment liquid to a surface—have been observed to produce a cleaner surface (i.e., a surface with less debris) than the same surface treated with water.

Finally, Applicant has observed that surface treatment articles that include a substrate loaded with active agent(s) described herein can produce a remarkably streak free shine when applied to various surfaces, particularly granite and stainless steel. Without wishing to be bound by theory, it is believed that the streak free shine achieved with such surface treatment articles is due to the ability of the surface treatment liquids described herein (particularly water loaded with dissolved ozone, ozone degradation products, and/or ozone reaction products) to quickly evaporate from a surface while leaving little to no residue behind.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are within the scope of the present invention, which is not to be limited except by the claims.

What is claimed is:

1. A surface treatment article, comprising a substrate loaded with a surface treatment liquid, wherein:
the surface treatment liquid comprises a carrier loaded with an active agent;
the carrier comprises water; and
the active agent comprises dissolved ozone, an ozone degradation product, an ozone reaction product, or a combination of two or more thereof.

2. The surface treatment article of claim 1, wherein:
the surface treatment liquid consists essentially of said carrier loaded with said active agent;
the carrier consists essentially of water; and
the active agent consists essentially of dissolved ozone, an ozone degradation product, an ozone reaction product, or a combination of two or more thereof.

3. The surface treatment article of claim 1, wherein a concentration of active agent in the carrier is greater than or equal to about 0.03 parts per million.

4. The surface treatment article of claim 3, wherein a concentration of active agent in said carrier is greater than or equal to about 0.1 parts per million.

5. The surface treatment article of claim 3, wherein a minimum residence time of said active agent in said carrier is at least 60 seconds.

6. The surface treatment article of claim 5, wherein a minimum residence time of said active agent in said carrier is at least 300 seconds.

7. The surface treatment article of claim 1, wherein said substrate comprises a sponge, a woven article, a non-woven article, or a combination of two or more thereof.

8. The surface treatment article of claim 7, wherein the substrate is a non-woven or woven article.

9. The surface treatment article of claim 8, wherein the substrate is a cotton cloth, microfiber cloth, or a combination thereof.

10. The surface treatment article of claim 9, wherein the substrate is a microfiber cloth.

11. The surface treatment article of claim 1, wherein the carrier is loaded with the active agent by exposing the substrate wetted with the carrier to ozone gas in a chamber.

12. The surface treatment article of claim 7, wherein:
the substrate comprises a first surface and a second surface substantially opposite the first surface; and
the substrate further comprises at least one absorbent layer disposed on the first surface, the second surface, or both the first surface and the second surface.

13. The surface treatment article of claim 7, wherein the substrate comprises first and second regions, and an absorbent layer is present between the first and second regions.

14. A method for forming a surface treatment article, comprising:
providing a substrate;
loading the substrate with a carrier; and
contacting the substrate loaded with the carrier with a sanitizing gas to form a surface treatment article loaded with a surface treatment liquid, the surface treatment liquid comprising the carrier liquid loaded with an active agent;
wherein the carrier comprises water and the active agent comprises dissolved ozone, an ozone degradation product, an ozone reaction product, or a combination of two or more thereof.

15. The method of claim 14, wherein:
the surface treatment liquid consists essentially of said carrier and said active agent;
said carrier consists essentially of water; and
said active agent consists essentially of dissolved ozone, an ozone degradation product, an ozone reaction product, or a combination of two or more thereof.

16. The method of claim 14, wherein a concentration of said active agent in said carrier is greater than or equal to about 0.03 parts per million.

17. The method of claim 16, wherein a minimum residence time of said active agent in said carrier is at least 300 seconds.

18. The method of claim 14, wherein loading the substrate with the carrier comprises wetting the substrate with the carrier to a drip dry state.

19. The method of claim 14, wherein contacting the substrate loaded with the carrier with a sanitizing gas comprises placing the substrate loaded with the carrier into a chamber and introducing the sanitizing gas into the chamber.

20. The method of claim 14, wherein said substrate comprises a sponge, a woven article, a non-woven article, or a combination of two or more thereof.

21. The method of claim 20, wherein the substrate is a cotton cloth, microfiber cloth, or a combination thereof.

22. The method of claim 14, wherein:
the substrate comprises a first surface and a second surface substantially opposite the first surface; and
the substrate further comprises at least one absorbent layer disposed on the first surface, the second surface, or both the first surface and the second surface.

23. The method of claim 14, wherein the substrate comprises first and second regions, and an absorbent layer is present between the first and second regions.
